(19) United States
(12) Patent Application Publication
(10) Pub. No.: US 2026/0287984 A1
(43) Pub. Date: Sep. 24, 2026

(54) Pantera Tether Plate

(71) Applicant: Tomás Andrés Hein, Barcelona (ES)

(72) Inventor: Tomás Andrés Hein, Barcelona (ES)

(21) Appl. No.: 19/086,286

(22) Filed: Mar. 21, 2025

(51) Int. Cl. G03B 17/56

(52) U.S. Cl. CPC G03B 17/566; G03B 17/561

(57) ABSTRACT

A modular camera plate designed for secure cable management and tripod mounting is disclosed. The device comprises a top cover and a bottom cover that, when assembled, form a housing configured to enclose and retain a cable using an integrated set of teeth. The teeth exert a controlled clamping force on the cable, preventing unintended displacement while allowing for intentional insertion and removal. The top and bottom covers are secured together using fastening elements, such as screws, ensuring structural stability while permitting disassembly for cable repositioning. The modular camera plate is further configured to serve as a mounting interface for a camera, allowing attachment to tripods or other support structures. By integrating cable retention within the mounting plate, the invention enhances workflow efficiency, reduces strain on cables and connection points, and prevents accidental disconnections during camera operation.

### BACKGROUND OF THE INVENTION

### Field of Invention

The present invention pertains to the field of camera support systems, and more particularly, to a modular camera plate configured to provide a secure cable management mechanism when shooting tethered to a computer via USB cable, while serving as a mounting interface for tripods and other support structures. The invention is directed toward mitigating cable displacement and inadvertent disconnections during camera operation, thereby enhancing the stability, reliability, and operational efficiency of professional imaging equipment.

### Brief Summary of the Invention

The present invention provides a modular camera plate designed for secure cable management and stable tripod mounting without requiring disassembly for cable insertion or removal. The device comprises a top cover and a bottom cover that are assembled at the factory for manufacturing purposes, forming a unitary structure. A cable is inserted through a dedicated cable canal, where integrated teeth exert a controlled gripping force when the cable is pulled in one direction and release it when pulled in the opposite direction, ensuring secure retention while allowing for easy removal. Fastening elements, such as screws, provide structural integrity and are generally not intended for regular user disassembly, although selective access is possible for maintenance. The plate further includes an Arca-style dovetail and a ¼″-20 UNC threaded hole, ensuring compatibility with standard grip devices. Unlike previous designs that required removal of the plate from the camera to disconnect the cable, the present invention allows the plate to remain mounted at all times while permitting quick and efficient cable removal, thereby enhancing workflow efficiency, reducing cable strain, and improving reliability in professional imaging applications.

### BRIEF DESCRIPTION OF THE FIGURES

FIG. 1 presents an internal top-down view of the device (10), depicting the top cover (14), bottom cover (12), teeth (16), ¼″-20 UNC thread (18), and Arca-style dovetail (22) for tripod mounting.

FIG. 2 illustrates a top-down view of the modular camera plate (10), showing the top cover (14), bottom cover (12), teeth (16) for cable retention, and 1/4″-20 UNC thread (18) for tripod mounting.

FIG. 3 provides an internal bottom-up view of the device (10), showing the bottom cover (12), top cover (14), teeth (16), ¼″-20 UNC thread (18), anti-slip pads (3) and Arca-style dovetail (22) for mounting compatibility.

FIG. 4 demonstrates the device (10) in use, illustrating the top cover (14), bottom cover (12), fastening screw/bolt (15), teeth (16), camera (30), computer (32), where a camera is connected to a usb port on the computer with the invention managing the tether cable in between.

FIG. 5 shows a head-on close-up view of the device (10), detailing the top cover (14), bottom cover (12), fastening screw/bolt (15), and teeth (16) for securing the cable.

FIG. 6 presents the device (10) integrated into a camera setup, showing the wire (20) routed through the invention while mounted onto a camera (30).

### DETAILED DESCRIPTION

The present invention relates to a modular camera plate designed to provide both secure cable management when shooting tethered to a computer and a stable mounting interface for tripods and other support systems. The invention addresses common issues of unintended cable displacement, disconnection, and damage to camera ports, which can lead to signal interruptions, equipment damage, and workflow inefficiencies in professional imaging applications. Unlike conventional designs that require disassembly or plate removal to manage cables, the present invention allows the plate to remain attached to the camera while permitting quick cable insertion and removal.

The device comprises a top cover and a bottom cover, which are assembled at the factory as part of the manufacturing process. These two covers enclose an integrated cable canal, allowing a cable to be inserted without requiring disassembly of the plate. Within the canal, a set of teeth are strategically positioned to engage with the cable, applying a controlled gripping force when the cable is pulled in one direction while allowing for release when pulled in the opposite direction. This mechanism ensures that the cable remains securely in place during normal operation but can be intentionally removed or replaced when necessary.

To maintain the structural integrity of the device, the top and bottom covers are secured together using three or more assembly screws. These screws are not intended for routine disassembly but are essential for the factory-assembled construction of the device. Additionally, a ¼″-20 UNC threaded bolt/screw is provided for direct mounting onto a camera body. Additionally a ¼″-20 UNC threaded hole is provided, allowing compatibility with industry-standard tripod mounts and support systems. Furthermore, the invention features an Arca-style dovetail, which enables secure attachment to quick-release tripod heads and grip accessories.

A key advantage of the invention is that it eliminates the need to remove the plate from the camera to unplug the cable. In prior designs, the cable was sandwiched between the plate and the camera body, requiring the user to completely remove the plate before disconnecting the cable. This design was cumbersome and inefficient for professionals who frequently connect and disconnect cables during operation. By contrast, the present invention allows the plate to remain securely mounted at all times, with the cable accessible for removal in seconds.

The modular camera plate is constructed from durable yet lightweight materials, ensuring long-term reliability while minimizing additional weight on the camera system. The form factor is optimized to provide secure cable retention without interfering with other camera components or obstructing essential controls. While the device is designed to withstand professional use, the only routine maintenance required is the potential replacement of screws if necessary.

By integrating cable management within a mounting plate, the invention enhances workflow efficiency, prevents accidental cable disconnections, and protects delicate camera ports from damage. The combination of a factory-assembled structure, cable canal, directional gripping teeth, and tripod mounting compatibility makes this invention an essential tool for photographers, videographers, and other imaging professionals.

### DETAILED DESCRIPTION OF FIGURES

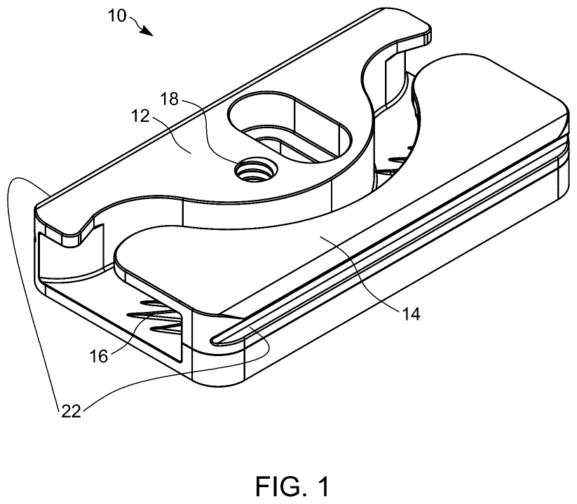

FIG. 1 presents an internal top-down view of the device (10), showing the interaction between the internal components. The top cover (14) and bottom cover (12) enclose the teeth (16), which apply a directional gripping force on the cable. The ¼″-20 UNC thread (18) is positioned at the bottom to enable secure mounting. Additionally, the Arca-style dovetail (22) is shown, allowing the plate to be attached to quick-release tripod heads or other grip accessories without additional adapters. This figure highlights the modular nature of the invention and its integration with professional camera support systems.

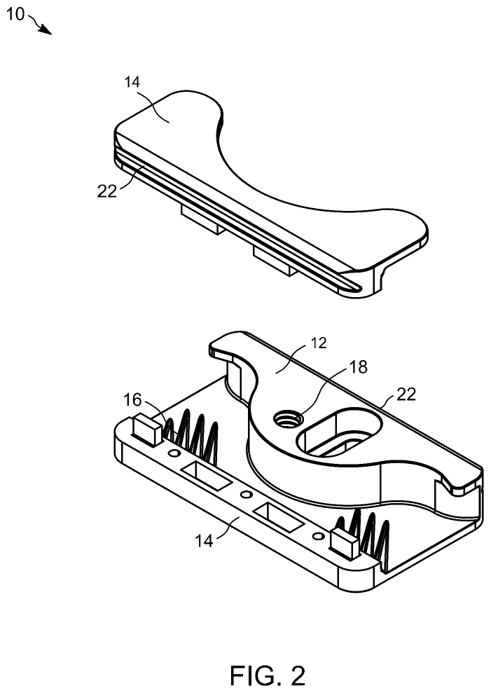

FIG. 2 illustrates a top-down view of the modular camera plate (10), depicting the top cover (14) and bottom cover (12) forming the external housing of the device. The teeth (16), positioned internally, function to secure a cable in place by exerting a controlled grip when the cable is inserted into the plate's cable canal. The ¼″-20 UNC thread (18) is also shown, which serves as the standard mounting interface for attaching the plate to tripods or other support systems.

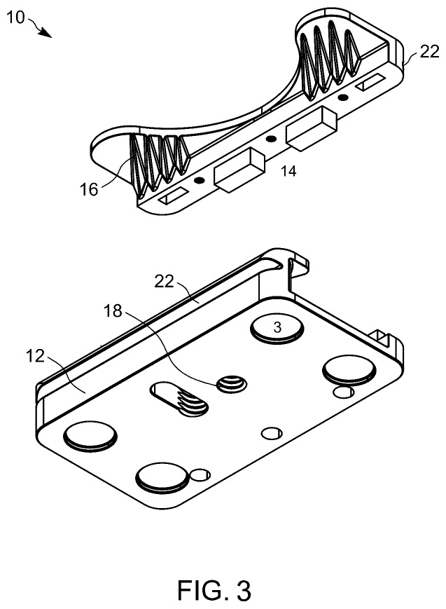

FIG. 3 provides an internal bottom-up view of the device (10), further illustrating the structural layout of its components. The bottom cover (12) is the primary mounting surface, featuring the ¼″-20 UNC thread (18) for tripod compatibility. The teeth (16) within the plate continue to be visible, demonstrating how they interface with the inserted cable. The Arca-style dovetail (22) is also shown, reinforcing the plate's compatibility with industry-standard mounting systems. This view clarifies the underside configuration of the invention, ensuring proper attachment and cable retention. Anti-slip silicone pads (3) are on the bottom plate to avoid turning movement when mounted on the camera. These pads go towards the camera so the plate doesn't turn.

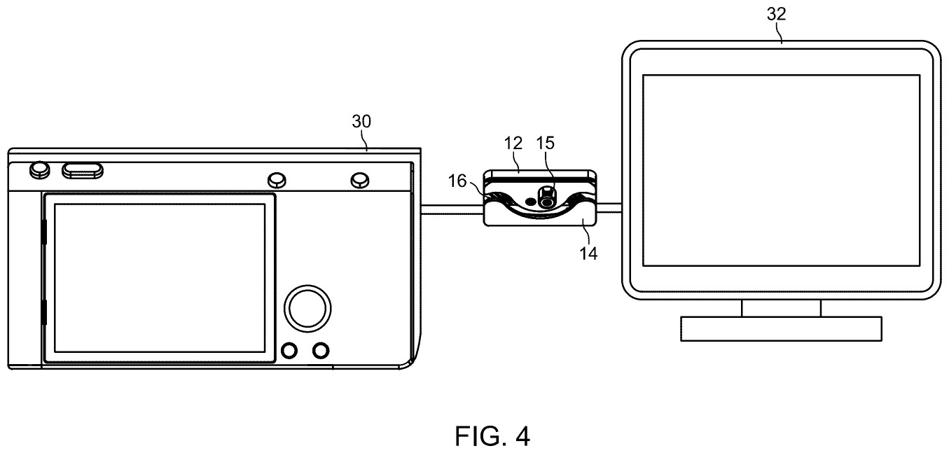

FIG. 4 depicts the device (10) in operation, showing how it facilitates cable management between a camera (30) and a computer (32). The top cover (14) and bottom cover (12) remain fully assembled, while the fastening screw/bolt (15) secures the invention in place. The teeth (16) are actively engaged with the cable, ensuring a firm connection while allowing easy disconnection when needed. This figure highlights the real-world application of the invention, demonstrating its role in protecting ports, preventing cable strain, and improving workflow efficiency in professional imaging environments.

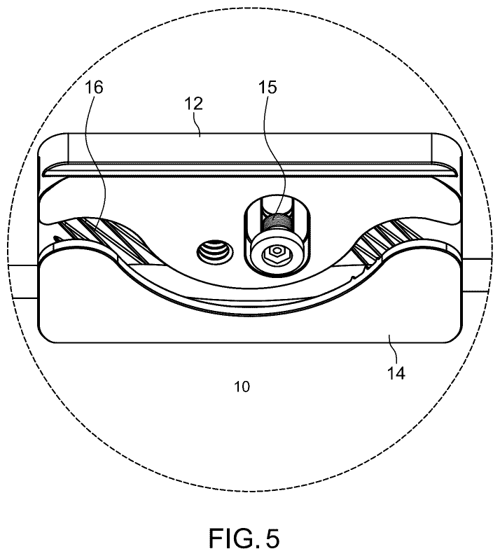

FIG. 5 presents a head-on close-up view of the device (10), focusing on the top cover (14), bottom cover (12), fastening screw/bolt (15), and teeth (16). This perspective emphasizes the structure and function of the teeth (16), which apply controlled force to the cable. The fastening mechanism is clearly shown, ensuring stability without requiring user disassembly. This view further clarifies how the cable canal allows for easy insertion and removal of the cable without interfering with the plate's attachment to the camera.

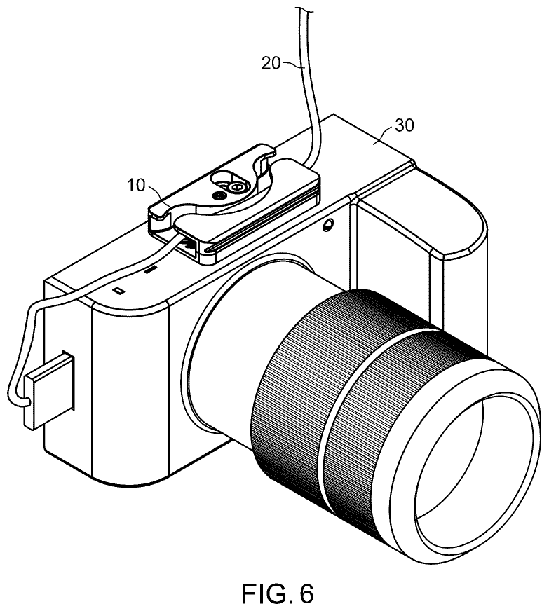

FIG. 6 showcases the device (10) integrated into a camera setup, with the wire (20) routed through the invention while mounted onto a camera (30). This view highlights the core functionality of the device—securing the cable in place while remaining attached to the camera at all times. Unlike prior designs, which required removing the plate to unplug the cable, this invention allows for fast and convenient cable removal without disrupting the mounting setup.

What is claimed is:

1. A modular camera plate for securing a cable and providing a mounting interface for a camera, the modular camera plate comprising:
a. a top cover;
b. a bottom cover configured to engage with the top cover to form a housing;
c. a set of teeth disposed within the housing and configured to retain a cable by exerting a clamping force; and
d. at least one fastening element securing the top cover to the bottom cover, wherein the housing and teeth configuration permit cable insertion and removal without disassembly of the top cover and bottom cover.

2. The modular camera plate of claim 1, wherein the top cover and bottom cover are removably secured using screws as the fastening element.

3. The modular camera plate of claim 1, wherein the teeth are integrally formed with at least one of the top cover or the bottom cover.

4. The modular camera plate of claim 1, wherein the housing is configured to be mounted to a camera body or a tripod support structure.

5. The modular camera plate of claim 1, wherein the teeth are shaped to accommodate different cable diameters while maintaining a secure grip.

6. The modular camera plate of claim 4, wherein the housing includes an interface for attaching to a tripod mounting system.

7. The modular camera plate of claim 2, wherein the screws are not intended for regular user disassembly but enable selective maintenance.

8. The modular camera plate of claim 1, wherein the top cover and bottom cover are composed of a lightweight, durable material resistant to mechanical stress.

9. The modular camera plate of claim 1, wherein the cable retention mechanism reduces strain on the cable and prevents disconnection from a camera port during operation.

10. The modular camera plate of claim 1, wherein the housing is designed to minimize interference with other camera components while securing the cable in place.

11. The modular camera plate of claim 1, wherein the modular camera plate defines a cable canal accessible externally to allow a cable to be inserted or removed without requiring disassembly of the plate from the camera.

12. The modular camera plate of claim 1, further comprising anti-slip pads disposed on the bottom cover to prevent rotation relative to a camera.

13. The modular camera plate of claim 1, wherein the top cover and bottom cover comprise aluminum alloy or composite material.
